(19) United States
(12) Patent Application Publication
(10) Pub. No.: US 2022/0292235 A1
(43) Pub. Date: Sep. 15, 2022

(54) ARITHMETIC APPARATUS, ARITHMETIC METHOD, AND NON-TRANSITORY COMPUTER READABLE MEDIUM STORING PROGRAM

(71) Applicants: NEC CORPORATION, Tokyo (JP); TOKYO INSTITUTE OF TECHNOLOGY, Tokyo (JP)

(72) Inventors: Yuki SUSA, Tokyo (JP); Hidetoshi NISHIMORI, Tokyo (JP)

(73) Assignees: NEC CORPORATION, Tokyo (JP); TOKYO INSTITUTE OF TECHNOLOGY, Tokyo (JP)

(21) Appl. No.: 17/639,644

(22) PCT Filed: Sep. 3, 2019
(86) PCT No.: PCT/JP2019/034618

§ 371 Date: Mar. 2, 2022

(51) Int. Cl. G06F 30/20; G06F 17/11

(52) U.S. Cl. CPC G06F 30/20; G06F 17/11; G06F 2111/10

(57) ABSTRACT

An arithmetic apparatus includes a control unit that changes a first weighting coefficient assigned to a constraint term included in Hamiltonian so that the first weighting coefficient changes differently from a second weighting coefficient assigned to an objective term included in the Hamiltonian in process of reducing quantum fluctuations to obtain a ground state of the Hamiltonian used for solving a combinatorial optimization problem.

### TECHNICAL FIELD

The present disclosure relates to an arithmetic apparatus, an arithmetic method, and a non-transitory computer readable medium storing a program.

### BACKGROUND ART

Quantum annealing is a method of solving a combinatorial optimization problem by using a quantum fluctuation. The combinatorial optimization problem is a problem of searching for an optimal set of variables on the basis of a specified evaluation (objective) function, such as the traveling salesman problem, for example.

The traveling salesman problem is a problem of finding the shortest possible route when a salesman visits each of given cities exactly once and returns to the origin city. Regarding this traveling salesman problem, it is known that as the number of cities increases, the number of possible routes increases explosively, which makes it extremely difficult to find an optimal solution.

In quantum annealing, an optimal solution of the combinatorial optimization problem is calculated as the ground state of the Ising model. Specifically, quantum annealing searches for the ground state of the Ising model from possible values of a plurality of quantum bits.

Quantum annealing first applies quantum fluctuations to all quantum bits. Next, in the process of reducing quantum fluctuations, it strengthens interactions between quantum bits defined on the basis of the combinatorial optimization problem. Then, by reading the state of quantum bits, the ground state of the Ising model is obtained, and thereby a solution of the combinatorial optimization problem is obtained.

The Hamiltonian used in quantum annealing is represented by the sum of a constraint term corresponding to a constraint condition to be met by quantum bits and an objective term to be optimized. In the related art, a weighting coefficient of the objective term and a weighting coefficient of the constraint term are increased at the same rate in the process of reducing quantum fluctuations.

On the other hand, Patent Literature 1 discloses a technique of solving a combinatorial optimization problem by using a neural network. Patent Literature 1 defines the sum of a function φ₁ representing a constraint condition and an objective function φ₂ as a total energy function φ. An optimal solution or a suboptimal solution is obtained by setting the initial state to the neural network and making a state transition according to a transition rule that reduces the total energy function φ.

Patent Literature 1 shows that the accuracy rate is improved by setting the initial state so as to reduce φ₁. In this case, the effect of the constraint condition φ₁ is small in the early stage, and the effect of the constraint condition φ₁ increases with the passage of time.

### CITATION LIST

### Patent Literature

Patent Literature 1: Japanese Unexamined Patent Application Publication No. H08-050572

### SUMMARY OF INVENTION

### Technical Problem

The technique disclosed in Patent Literature 1 appropriately sets the initial state of the neural network and thereby changes the degree of the effect of an objective term and the effect of a constraint term. However, since the technique disclosed in Patent Literature 1, which is applied to the neural network, is unable to be applied to quantum annealing, and therefore it is unable to apply the technique disclosed in Patent Literature 1 to quantum annealing and solve a combinatorial optimization problem.

The present invention has been accomplished to solve the above problem and an object of the present disclosure is thus to provide an arithmetic apparatus, an arithmetic method, and a non-transitory computer readable medium storing a program capable of adjusting the degree of the effect of an objective term and the effect of a constraint term in the process of reducing quantum fluctuations.

### Solution to Problem

An arithmetic apparatus according to the present disclosure includes a control unit configured to change a first weighting coefficient assigned to a constraint term included in Hamiltonian so that the first weighting coefficient changes differently from a second weighting coefficient assigned to an objective term included in the Hamiltonian in process of reducing quantum fluctuations to obtain a ground state of the Hamiltonian used for solving a combinatorial optimization problem.

An arithmetic method according to the present disclosure includes changing a first weighting coefficient assigned to a constraint term included in Hamiltonian so that the first weighting coefficient changes differently from a second weighting coefficient assigned to an objective term included in the Hamiltonian in process of reducing quantum fluctuations to obtain a ground state of the Hamiltonian used for solving a combinatorial optimization problem.

A non-transitory computer readable medium according to the present disclosure stores a program that causes a computer to perform processing of changing a first weighting coefficient assigned to a constraint term included in Hamiltonian so that the first weighting coefficient changes differently from a second weighting coefficient assigned to an objective term included in the Hamiltonian in process of reducing quantum fluctuations to obtain a ground state of the Hamiltonian used for solving a combinatorial optimization problem.

### Advantageous Effects of Invention

According to the present disclosure, there are provided an arithmetic apparatus, an arithmetic method, and a non-transitory computer readable medium storing a program capable of changing the degree of the effect of an objective term and the effect of a constraint term in the process of reducing quantum fluctuations.

### BRIEF DESCRIPTION OF DRAWINGS

FIG. 1 is a schematic view showing an example of the ground state.

FIG. 2 is a schematic view showing an overview of searching for the ground state in quantum annealing.

FIG. 3 is a schematic view showing an overview of quantum annealing.

FIG. 4 is a schematic view showing an overview of the Hamiltonian in quantum annealing.

FIG. 5 is a graph showing the relationship between an optimal solution and a solution close to the optimal.

FIG. 6 is a graph showing an example of an energy difference in quantum annealing.

FIG. 7 is a schematic view showing an overview of the LHZ model.

FIG. 8 is a schematic view showing an overview of the fully connected Ising model.

FIG. 9 is a block diagram showing a configuration of an arithmetic apparatus according to a first example embodiment.

FIG. 10 is a block diagram showing a configuration of an arithmetic apparatus according to a second example embodiment.

FIG. 11 is a schematic view showing a change in a weighting coefficient of a constraint term according to the second example embodiment.

FIG. 12 is a graph showing the energy differences of 1000 random patterns of combinatorial optimization problems in the second example embodiment.

FIG. 13 is a graph showing a success percentage in the case where a weighting coefficient is set for each constraint term in an example of a randomly generated problem.

FIG. 14 is a graph showing the relationship between an energy difference and the power of C(s) in the second example embodiment.

FIG. 15 is a graph showing the relationship between an energy difference and the number of quantum bits in the second example embodiment.

FIG. 16 is a graph showing a phase diagram at absolute zero in the second example embodiment.

FIG. 17 is a graph showing a phase diagram at finite temperature in the second example embodiment.

FIG. 18 is a graph showing a phase diagram in the case of including a random magnetic field in the second example embodiment.

FIG. 19 is a graph showing the strength of phase transition in the second example embodiment.

FIG. 20 is a block diagram showing a configuration example of hardware.

### EXAMPLE EMBODIMENTS

Prior to describing example embodiments, an overview of quantum annealing is described first. Quantum annealing is a method of solving a combinatorial optimization problem by using a quantum fluctuation. The quantum fluctuation is also called a transverse magnetic field.

The combinatorial optimization problem is a problem of searching for an optimal set of variables on the basis of a specified evaluation (objective) function. The combinatorial optimization problem is, for example, a problem of finding a combination of variables that minimizes a certain given evaluation function.

The combinatorial optimization problem can be solved by finding possible values of variables in a brute force way. In the case of a typical combinatorial optimization problem, the total number of combinations increases exponentially as the number of variables increases. Accordingly, the required computation time increases exponentially, which makes it difficult to solve the problem.

An example of the combinatorial optimization problem is the traveling salesman problem. The traveling salesman problem is a problem of finding a route with the minimum total travel cost (distance) among routes that visit each of given cities exactly once and then return to the origin city. In the traveling salesman problem, the total number of combinations when the number of cities is 5 is 120 patterns, and it is three million or more when the number of cities is 10 or more. Further, when the number of cities increases to 20, it is difficult to solve the problem in a brute force way with the practical computation time.

Quantum annealing is a method of solving a combinatorial optimization problem by converting the combinatorial optimization problem into the Ising model and searching for the ground state of the Ising model. The Ising model is a model where the Hamiltonian is represented by the following Expression (1).

[Expression 1]

H_{Ising}=−Σ_{i<j}^{N}Jᵢⱼσᵢ^{z}σⱼ^{z}−Σᵢ₌₁^{N}hᵢσᵢ^{z} (1)

The symbol σ^{z}ᵢ indicates a spin (quantum bit). The first term Jᵢⱼ on the right-hand side of Expression (1) is a coupling constant that represents the strength of interactions between σ^{z}ᵢ and σ^{z}ⱼ. The second term hᵢ on the right-hand side is a magnetic field. Converting the combinatorial optimization problem into the Ising model corresponds to setting the coupling constant in Expression (1). Quantum annealing searches for a non-trivial minimum energy state (ground state) corresponding to Expression (1). Then, an optimal combination of quantum bits is obtained from the ground state.

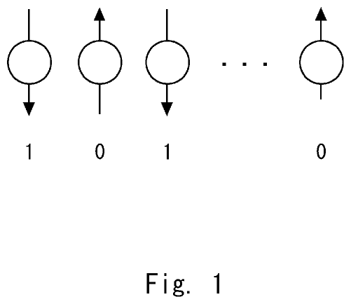

The non-trivial ground state is represented as the state of a spin as shown in FIG. 1. When the upward spin is 0 and the downward spin is 1, it can be represented as a combination of 0 and 1.

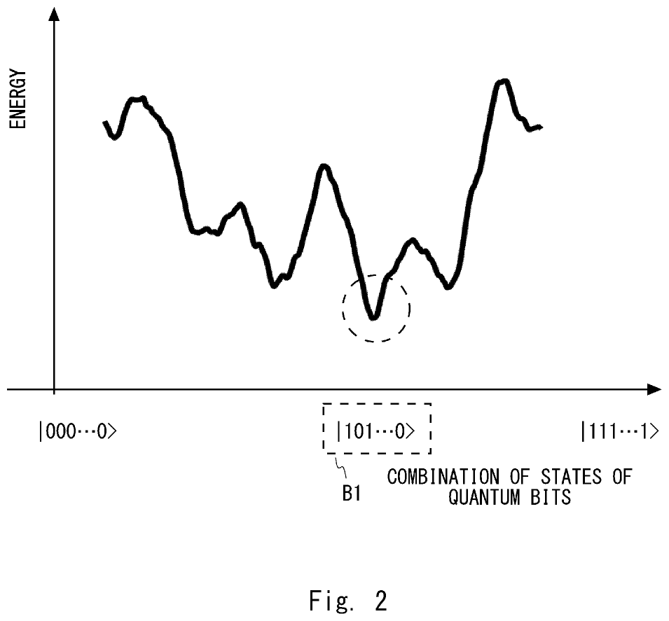

The vertical axis of FIG. 2 indicates the energy of the Ising model. The horizontal axis of the graph indicates a combination of possible states of quantum bits. The ground state B1 is obtained by searching for the state with the minimum energy.

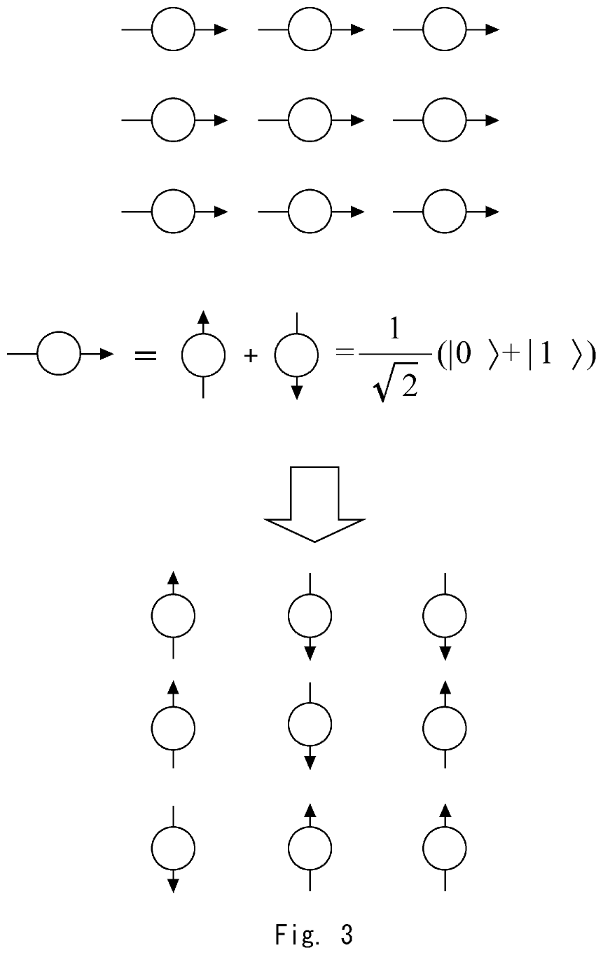

FIG. 3 is a schematic view showing an overview of quantum annealing. Quantum annealing first sets the Hamiltonian represented by Expression (1) on the basis of the combinatorial optimization problem. Next, it applies quantum fluctuations to all quantum bits in Expression (1). When quantum fluctuations are applied, the quantum bits become the state where an upward spin and a downward spin overlap. After that, quantum annealing gradually reduces quantum fluctuations, and simultaneously gradually increases interactions between quantum bits that represent the combinatorial optimization problem. As a result, a combination of quantum bits that minimizes the energy is obtained.

The above-described process is represented by Expression (2).

[Expression 2]

H(s)=−(1−s)Σᵢ₌₁^{N}σᵢ^{x}+sH_{Ising} (2)

In Expression (2), H_{Ising} is the Hamiltonian of the Ising model that is used for solving the combinatorial optimization problem. The symbol s is a parameter related to time, and it is an increasing function of time. At the start of annealing, s=0. At the completion of annealing, s=1. The symbol σ^{x}ᵢ is an x-component of the spin, and the first term on the right-hand side corresponds to the quantum fluctuations. The quantum fluctuation term serves as a driver for executing quantum annealing.

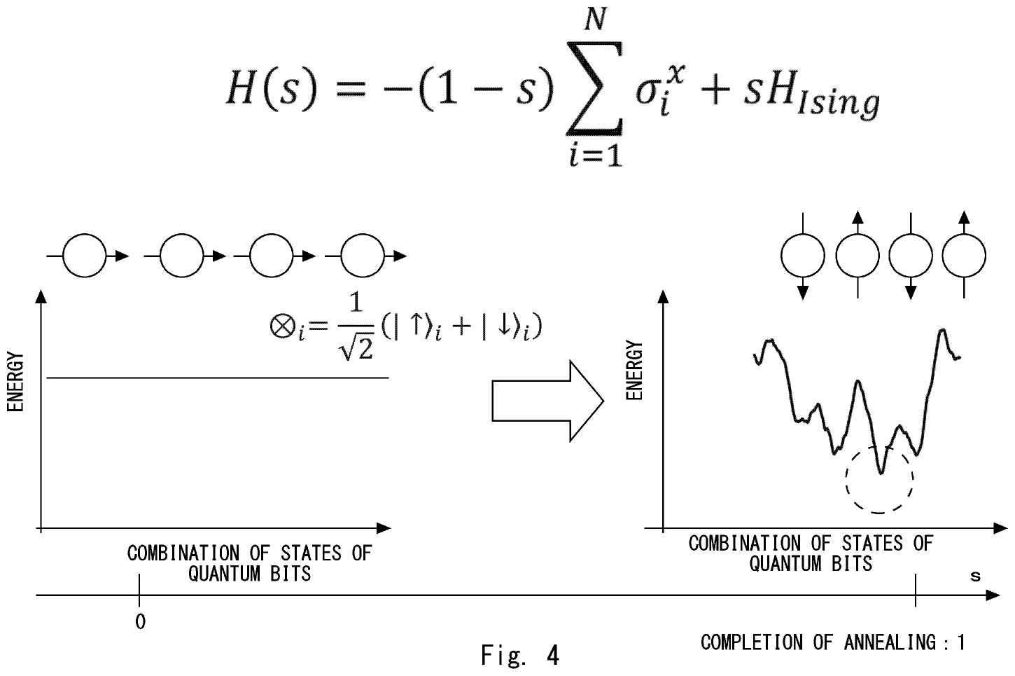

FIG. 4 is a schematic view showing an overview of the process of quantum annealing. At s=0, Expression (2) is only the first term on the right-hand side, and the quantum bits become the state where an upward spin and a downward spin overlap. At this time, the energy is constant for a combination of the states of quantum bits. At the completion of annealing, Expression (2) is only the second term on the right-hand side, and the quantum bits are the ground state of the Ising model. In other words, the quantum bits are the state corresponding to an optimal solution of the combinatorial optimization problem.

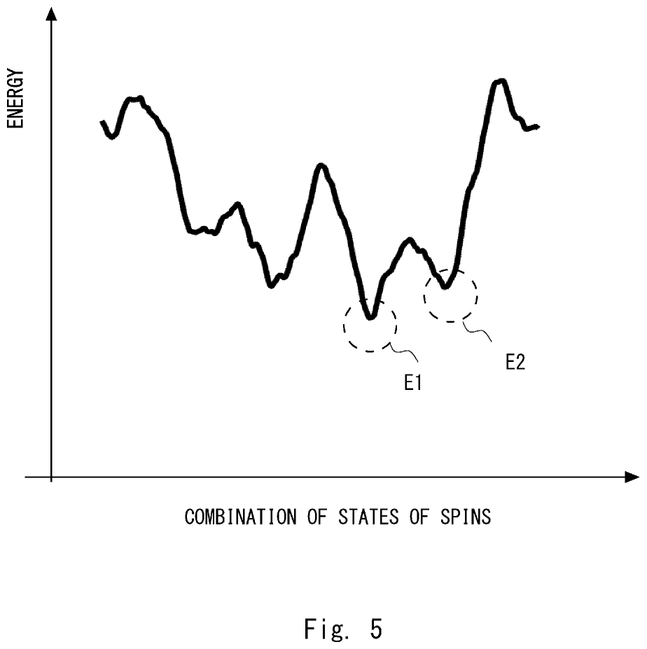

In quantum annealing, an optimal solution is definitely obtained by moving s from 0 to 1 over an infinite length of time. However, it is practically difficult to carry out computation for an infinite length of time. It is known that the lower limit of time required to obtain an optimal solution is obtained by an energy difference between an optimal solution and a solution close to the optimal. In FIG. 5, E1 is the energy of the optimal solution, and E2 is the energy of the solution close to the optimal. Then, the lower limit of required computation time can be estimated from a difference between E1 and E2.

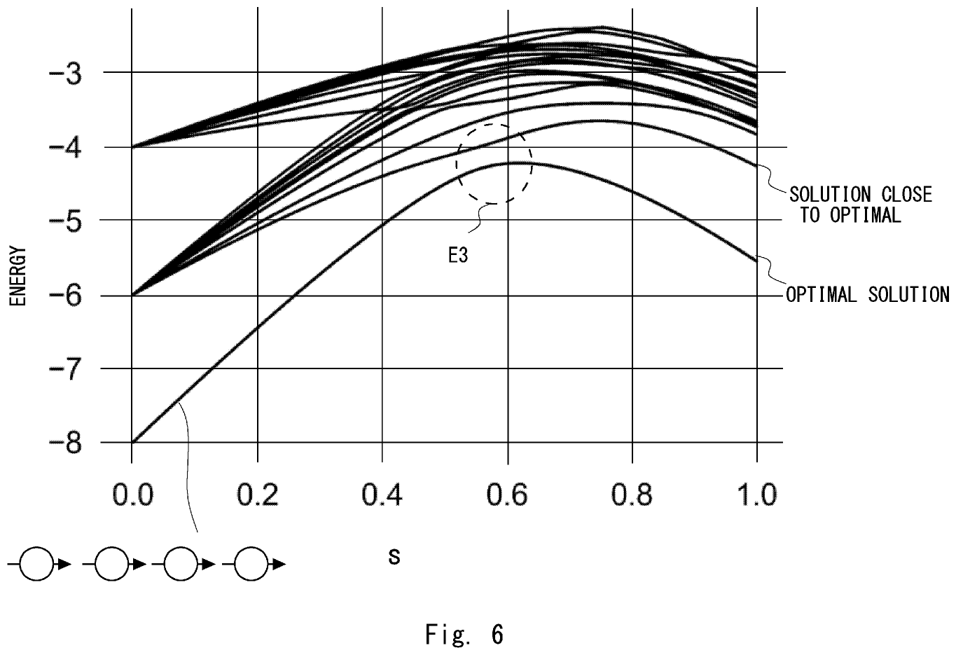

FIG. 6 is a graph showing an example of an energy difference in the process of quantum annealing. The horizontal axis is s. At s=0, the quantum bits are in the overlapping state, and s=1 is at the completion of annealing. In the area of E3, a difference between the energy indicating the optimal solution and the energy indicating the solution close to the optimal is minimum. When the minimum energy difference is min(ΔE), and the minimum time required to obtain the optimal solution is to, Expression (3) is established.

[Expression 3]

t₀∝min(ΔE)⁻² (3)

In other words, in the case where the annealing time is fixed, the probability of obtaining an optimal solution is small when min(ΔE) is small.

In sum, quantum annealing is a method of finding a combination of bits (0,1) that minimizes the energy of the Ising model by using the quantum fluctuations. A difference in energy is related to the degree of difficulty of the combinatorial optimization problem. It can be considered that the more difficult the combinatorial optimization problem is, the smaller the energy difference is. Further, in general terms, it is known that the larger the number of (quantum) bits required to solve the problem is, the smaller the energy difference is. Thus, as the number of cities increases in the traveling salesman problem, for example, it becomes more difficult to solve the problem.

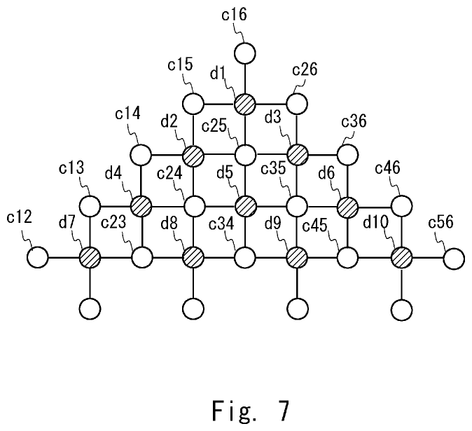

Next, the LHZ (W. Lechner, P. Hauke, and P. Zoller) model is described as a hardware configuration. Since the Ising model includes coupling between all quantum bits as represented by Expression (1), it is difficult to implement it as hardware. In view of this, the LHZ model as shown in FIG. 7 has been proposed (W. Lechner, P. Hauke, and P. Zoller, Sci Adv 1, (2015)). It is known that the LHZ model is a model that is logically equivalent to the Ising model, and is based on many-body interactions. The LHZ model can be implemented using hardware. The LHZ model is an architecture expressed by a local field in quantum bits and four-body interactions between quantum bits.

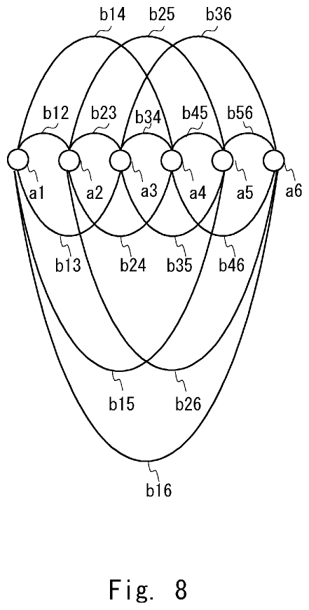

FIG. 8 shows the fully connected Ising model. Hereinafter, the relationship between the LHZ model shown in FIG. 7 and the fully connected Ising model shown in FIG. 8 is described. Quantum bits a1 to a6 in FIG. 8 are quantum bits in the fully connected Ising model. Couplings b12 to b56 represent couplings between the quantum bits a1 to a6 in the fully connected Ising model. For example, the coupling b12 represents the coupling between the quantum bits a1 and a2.

The quantum bits (physical bits) of the LHZ model shown in FIG. 7 are quantum bits c12 to c56. The quantum bits c12 to c56 correspond to the couplings b12 to b56 shown in FIG. 8. For example, the coupling b12 of the fully connected Ising model corresponds to the quantum bit c12 of the LHZ model. Interactions d1 to d10 indicate the many-body interactions in the LHZ model. For example, the interaction d1 represents four-body proximity interactions of the quantum bits c15, c16, c25, and c26.

When the LHZ model is used, the number K of physical bits that are required to represent the N logical bit is N(N−1)/2. The number of physical bits affects the energy difference that gives an indication of computation time of quantum annealing.

While the Hamiltonian of the fully connected Ising model is represented by Expression (1), the Hamiltonian is represented by Expression (4) when the LHZ model is used.

[Expression 4]

H_{LHZ}=−Σₖ^{K}Jₖσₖ^{z}−Σₗ^{L}σ_{(l,n)}^{z}σ_{(l,s)}^{z}σ_{(l,e)}^{z}σ(l,w)^{z} (4)

In the first term on the right-hand side, Jᵢⱼ in Expression (1) is replaced with Jₖ. The second term on the right-hand side in Expression (4), which is a term that represents a constraint condition to be satisfied by quantum bits, indicates the condition that the product of the four quantum bits around each of the interactions d1 to d10 is l. The symbol l (l indicates the lower-case alphabet of “L”) is a parameter that represents a constraint condition, and the number L of constraint conditions is (N−1)(N−2)/2.

In Expression (4), the second term on the right-hand side, which is a term representing a constraint condition imposed between quantum bits, is called a constraint term. Further, in Expression (4), the first term on the right-hand side is called an objective term. In this way, the constraint term is represented by many-body interactions of quantum bits. Further, the constraint term is represented by three or more body interactions in some cases. It is known that some of the combinatorial optimization problems involving many-body interactions are difficult to be solved by quantum annealing. Note that each of L number of terms representing the constraint condition in Expression (4) may be considered as a constraint term. In other words, Expression (4) can be considered to include a plurality of constraint terms.

Hereinafter, example embodiments will be described with reference to the drawings. Since the drawings are in a simplified form, the technical scope of the example embodiments should not be narrowly interpreted on the basis of the illustration of the drawings. Further, the same components are denoted by the same reference symbols and overlapping descriptions will be omitted.

### First Example Embodiment

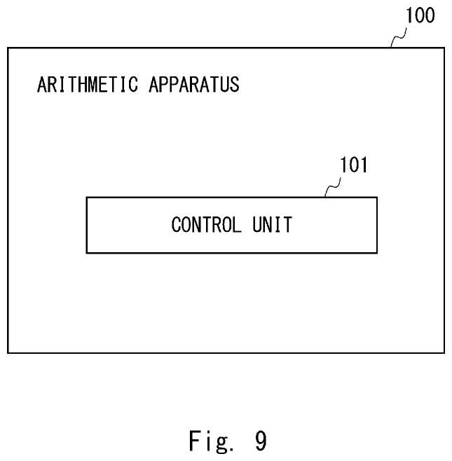

FIG. 9 is a block diagram showing a configuration of an arithmetic apparatus 100 according to a first example embodiment. The arithmetic apparatus 100 includes a control unit 101.

The arithmetic apparatus 100 is a device that calculates an optimal solution of a combinatorial optimization problem by quantum annealing. The combinatorial optimization problem is converted into the LHZ model or the like, and the arithmetic apparatus 100 obtains an optimal solution by calculating the ground state. In such a case, the Hamiltonian that represents the combinatorial optimization problem is represented by the sum of an objective term and a constraint term as in Expression (4).

It should be noted that this example embodiment is not limited to the case of using the LHZ model. It is applicable to other cases as long as the Hamiltonian that is set from the combinatorial optimization problem is classified into a constraint term representing a constraint condition imposed between quantum bits and an objective term different from that.

The arithmetic apparatus 100 includes quantum bit circuits composed of a plurality of quantum bits. Specifically, the arithmetic apparatus 100 searches for the ground statefrom possible states of the plurality of quantum bits. Further, the plurality of quantum bits are coupled with one another, and the strength of coupling is variable.

The arithmetic apparatus 100 increases a weight of the objective term and a weight of the constraint term in the process of reducing quantum fluctuations applied to the quantum bits. The Hamiltonian in quantum annealing is represented by Expression (5).

[Expression 5]

H=−A(s)[quantum fluctuation term]−(B(s)[obective term]+C(s)[constraint term]) (5)

The symbol s is a parameter dependent on time, and it increases with time. A weighting coefficient A(s) of the first term on the right-hand side is a decreasing function of s. A weighting coefficient of the objective term is B(s). A weighting coefficient C(s) of the constraint term is a function different from B(s). For example, B(s) is s, and C(s) is s². The arithmetic apparatus 100 changes the quantum fluctuations to be applied to the quantum bits, the interactions between the quantum bits, and the local field according to Expression (5).

The control unit 101 generates a control signal for controlling a weighting coefficient of the constraint term. The control unit 101 changes a weighting coefficient of the constraint term so that the weighting coefficient of the constraint term changes differently from a weighting coefficient of the objective term. The arithmetic apparatus 100 performs quantum annealing according to the signal generated by the control unit 101.

The arithmetic apparatus 100 according to this example embodiment is able to adjust the degree of effects of the objective term and the constraint term in the process of reducing quantum fluctuations. Thus, the arithmetic apparatus 100 makes an adjustment to increase the energy difference in quantum annealing and thereby reduces the required computation time.

### Second Example Embodiment

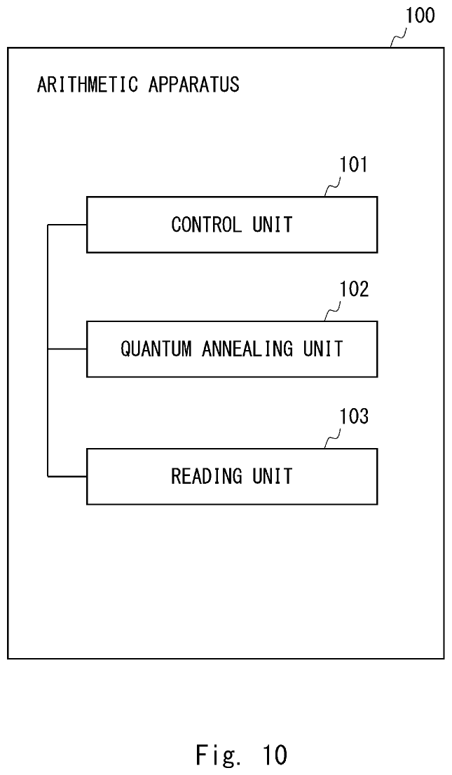

FIG. 10 is a block diagram showing a configuration of an arithmetic apparatus 100 according to a second example embodiment. The arithmetic apparatus 100 includes a control unit 101, a quantum annealing unit 102, and a reading unit 103.

The arithmetic apparatus 100 searches for a solution of a combinatorial optimization problem by using the Hamiltonian composed of a quantum fluctuation term, an objective term, and a constraint term. The objective term and the constraint term are parts that represent the combinatorial optimization problem. In this example embodiment, the Hamiltonian is represented by Expression (6).

[Expression 6]

H=−(1−s)[quantum fluctuation term]−(s[objective term]+C(s)[constraint term]) (6)

The symbol s is a parameter dependent on time, and it increases with time. The start point of quantum annealing corresponds to s=0, and the end point of quantum annealing corresponds to s=1. C(s) may be a function where C(0)=0 and C(1)=1 are satisfied.

In Expression (6), a weighting coefficient of the quantum fluctuation term is (1−s). A weighting coefficient of the objective term is s, and a weighting coefficient of the constraint term is C(s). C(s) is a function different from B(s)=s.

When the LHZ model is used, the Hamiltonian is represented by Expression (7). K is the number of physical bits, and K=N(N−1)/2 is established by using the number N of logical bits. L is the number of constraints, and it is represented as L=(N−1)(N−2)/2.

[Expression 7]

H(s)=−(1−s)Σₖ^{K}σₖ^{x}+(−sΣₖ^{K}Jₖσₖ^{z}−C(s)Σₗ^{L}σ_{(l,n)}^{z}σ(l,s)^{z}σ_{(l,e)}^{z}σ(l,w)^{z}) (7)

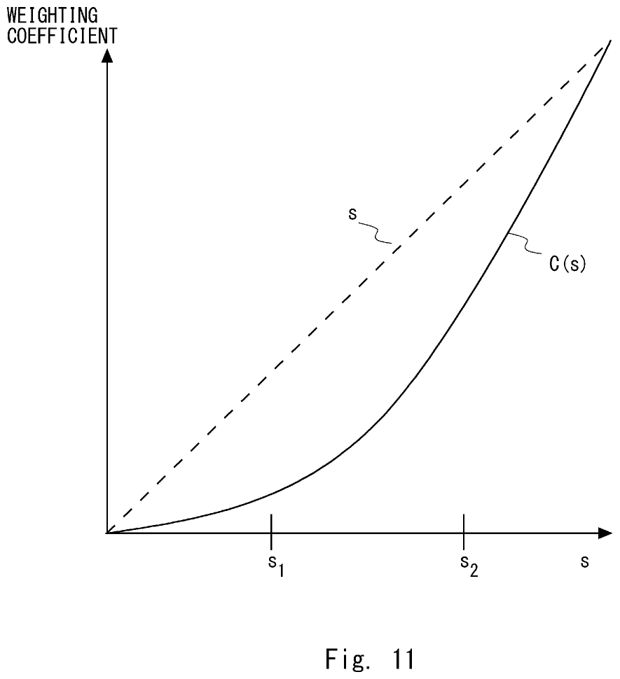

FIG. 11 is a view showing the relationship between s, which is the weighting coefficient of the objective term, and C(s), which is the weighting coefficient of the constraint term. The horizontal axis indicates s, and the vertical axis indicates the weighting coefficient. At the start of quantum fluctuations, s=0. At the end of quantum fluctuations, s=1. In the process of quantum fluctuations, the weighting coefficient s of the objective term and the weighting coefficient C(s) of the constraint term both increase. At the end of quantum fluctuations, s and C(s) may have the same value. In FIG. 11, the weight C(s) of the constraint term slowly increases at the early stage of annealing, and rapidly increases at the final stage of annealing.

In FIG. 11, there is a time interval during which C(s) falls below the weighting coefficient s of the objective term. The period during which C(s) falls below s may be a predetermined interval of quantum annealing, and it may be the early stage of quantum annealing. The early stage is a range from s=0 to s₁ at specified timing. The weighting coefficient C(s) of the constraint term may change so that the amount of increase is small at the early stage of quantum annealing and the amount of increase is large at the final stage of quantum annealing. The final stage is a range from s₂ at specified timing to s=1. s₁ and s₂ are arbitrary values that satisfy 0<s₁ and s₂<1 and also satisfy s₁<s₂. Further, C(s) may be s to the power of a value different from 1. C(s) is s², for example.

The control unit 101 inputs control signals to the quantum annealing unit 102. There may be a plurality of types of control signals. The control signals at least include a first control signal for controlling the weight (C(s)) of the constraint term in Expression (6), a second control signal for controlling the weight (s) of the objective term in Expression (6), and a third control signal for controlling the weight (1−s) of the quantum fluctuation term in Expression (6).

The control unit 101 may be a semiconductor device at room temperature or a superconducting circuit cooled to very low temperature of several mK (milli-Kelvin) to several K.

The quantum annealing unit 102 is a hardware implementation of the Ising model to which a specified combinatorial optimization problem is mapped. The quantum annealing unit 102 is a circuit where a plurality of quantum bit circuits are coupled to one another.

The quantum annealing unit 102 is implemented by a superconducting circuit using a superconducting material, for example. In the case where the quantum annealing unit 102 is implemented by a superconducting circuit, the quantum annealing unit 102 is cooled to very low temperature of several mK and operates. The quantum annealing unit 102 is cooled with use of a dilution refrigerator, for example.

The reading unit 103 reads the state of the quantum annealing unit 102. To be specific, the reading unit 103 reads the state of the plurality of quantum bit circuits that constitute the quantum annealing unit 102.

The reading unit 103 may be a semiconductor device at room temperature or a superconducting circuit cooled to very low temperature of several mK to several K.

The operation of the arithmetic apparatus 100 is described hereinafter. The control unit 101 changes the level of the third control signal so that the weight of the quantum fluctuation term gradually decreases as quantum annealing proceeds, and generates the first and second control signals so as to increase the weighting coefficient of the constraint term and the weighting coefficient of the objective term. The control unit 101 may change the levels of the first and second control signals so that the weight of the constraint term is smaller than the weight of the objective term at the early stage of quantum annealing, and the weight of the objective term and the weight of the constraint term are the same at the end of quantum annealing.

Then, the reading unit 103 reads the state of each quantum bit circuit of the quantum annealing unit 102 at the end of quantum annealing. This allows finding the state of each spin in the ground state (the state where the energy is minimum) of the Ising model. In other words, this allows finding an optimal solution of a specified combinatorial optimization problem mapped to the Ising model. An optimal solution of a desired combinatorial optimization problem is thereby obtained.

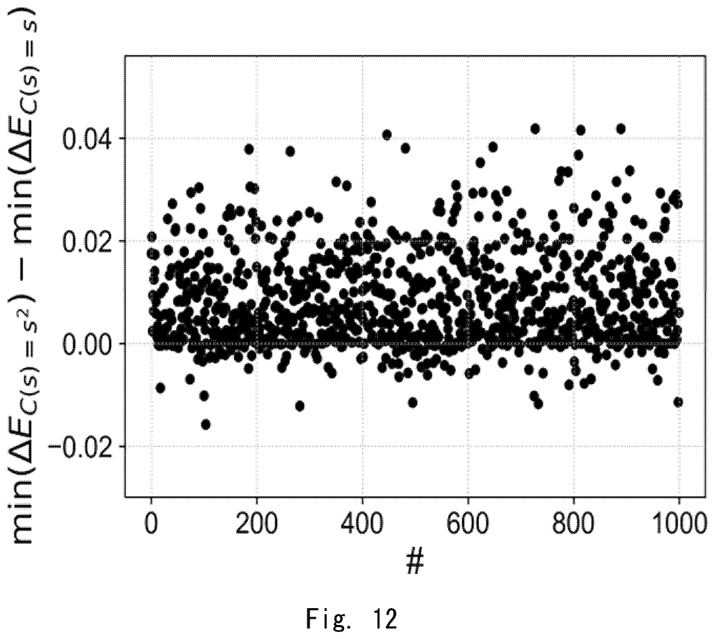

FIG. 12 is a view showing the effect of this example embodiment on a randomly generated combinatorial optimization problem. In the LHZ model, 1000 random patterns of combinatorial optimization problems were generated, and computation time when the weighting coefficient C(s) of the constraint term is s and when it is s² was evaluated.

For the evaluation of computation time, the minimum value of a difference between the energy of an optimal solution and the energy of a solution close to the optimal in the process of quantum annealing was used.

The vertical axis indicates a difference between an energy difference ΔE1 when the weighting coefficient of the constraint term C(s)=s² and an energy difference ΔE2 when C(s)=s. Since ΔE1 is greater in the area where the vertical axis is positive, necessary computation time is short, which shows that this example embodiment was effective. C(s)=s² was effective in about 85% of the 1000 randomly generated combinatorial optimization problems, and C(s)=s was effective in about 15% of them. Therefore, with use of this example embodiment, the efficiency is expected to be improved for about 85% of problems.

When there are a plurality of constraint terms, an appropriate weighting coefficient may be assigned to each of the constraint terms. In this case, the Hamiltonian using the LHZ model is represented by Expression (8).

[Expression 8]

H(s)=−(1−s)Σₖ^{K}σₖ^{x}+(−sΣᵢ^{K}Jₖσₖ^{z}−Σₗ^{L}Cₗ(s)σ_{(l,n)}^{z}σ_{(l,s)}^{z}σ_{(l,e)}^{z}σ_{(l,w)}^{z}) (8)

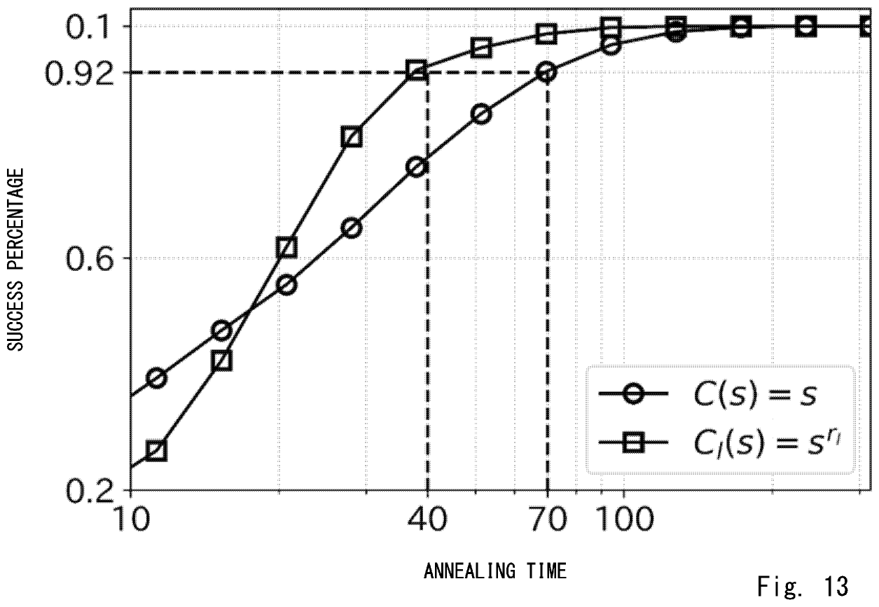

FIG. 13 is a semilogarithmic graph representing a success percentage in the case where a weighting coefficient is set for each constraint term in an example of a randomly generated problem. The horizontal axis indicates annealing time. The vertical axis indicates a success percentage. The success percentage is a percentage of obtaining the ground state as a result of quantum annealing.

According to FIG. 13, when the weighting coefficients of all constraint terms are C(s)=s, the annealing time that is necessary for the success percentage to reach about 92% is 70. On the other hand, when an appropriate weighting coefficient C₁(s)=s^{r_1} is selected for each constraint term, the annealing time that is necessary for the success percentage to reach about 92% is 40. Thus, this example embodiment allows the reduction of the annealing time that is necessary for computation. Specifically, when there are a plurality of constraint terms, the efficiency is increased by giving an appropriate weighting coefficient to each constraint term.

Next, the time required for computation is estimated for an example of the case where the Hamiltonian is represented by Expression (9) in this example embodiment. Note that a solution is the state where all spins point the same direction, which is trivial.

$$\begin{matrix}[ Expression 9 ] & \\ H ( s ) = - ( 1 - s ) {\sum }_{k}^{K} {σ}_{k}^{x} + ( - \frac{s}{2} {\sum }_{k}^{K} {σ}_{k}^{x} - C ( s ) {\sum }_{l}^{L} {σ}_{( l , m )}^{x} {σ}_{( l , s )}^{x} {σ}_{( l , e}^{x} {σ}_{( l , w )}^{x} ) & ( 9 )\end{matrix}$$

In Expression (9), K is the number of physical bits, and K=N(N−1)/2 is established with use of the number N of logical bits. l is a parameter representing a constraint. L is the number of constraints, and it is represented as L=(N−1)(N−2)/2.

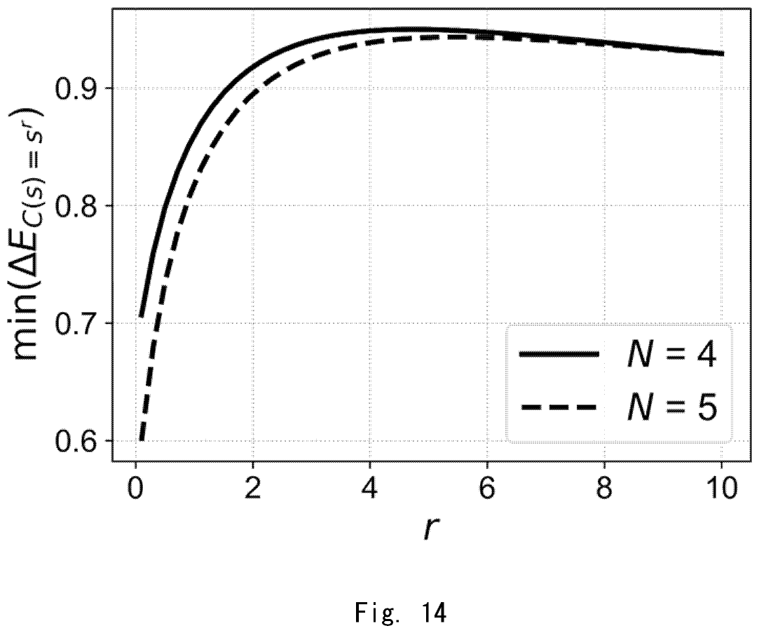

FIG. 14 shows a result of calculating an energy difference with a different power r when C(s)=s^{r} in Expression (9). Computation is carried out for the case where the number of logical bits is N=4 and where N=5. The vertical axis is an energy difference min(ΔE_{C(s)=s\hat{ }r}) between an optimal solution and a solution close to the optimal. The horizontal axis is the power r of C(s)=s^{r}. Since the energy difference increases with an increase of r, reduction of computation time is achieved.

A result of theory verification using the model represented by Expression (10) is described hereinbelow. When p=4 in Expression (10), a model with a constraint term involving many-body interactions is formed just like the LHZ model. Note that an optimal solution of Expression (10) is trivial just like Expression (9), and it is the state where all spins point the same direction.

$$\begin{matrix}[ Expression 10 ] & \\ H = - ( 1 - s ) {\sum }_{i = 1}^{N} {σ}_{i}^{x} + [ - \frac{s}{2} {\sum }_{i = 1}^{N} {σ}_{i}^{z} - C ( s ) {N ( \frac{1}{N} {\sum }_{i = 1}^{N} {σ}_{i}^{z} )}^{p} ] & ( 10 )\end{matrix}$$

It is known that when C(s)=s, the energy difference decreases exponentially relative to the number of quantum bits in the model represented by Expression (10). Thus, the combinatorial optimization problem represented by Expression (10) is a difficult problem for quantum annealing. It is difficult because as the size (quantum bits) of the problem increases, the time required for obtaining an optimal solution increases exponentially. The symbol p in Expression (10) represents the severity of a constraint of the constraint term, and it is unable to overcome the difficulty regardless of any schemes if p approaches infinity.

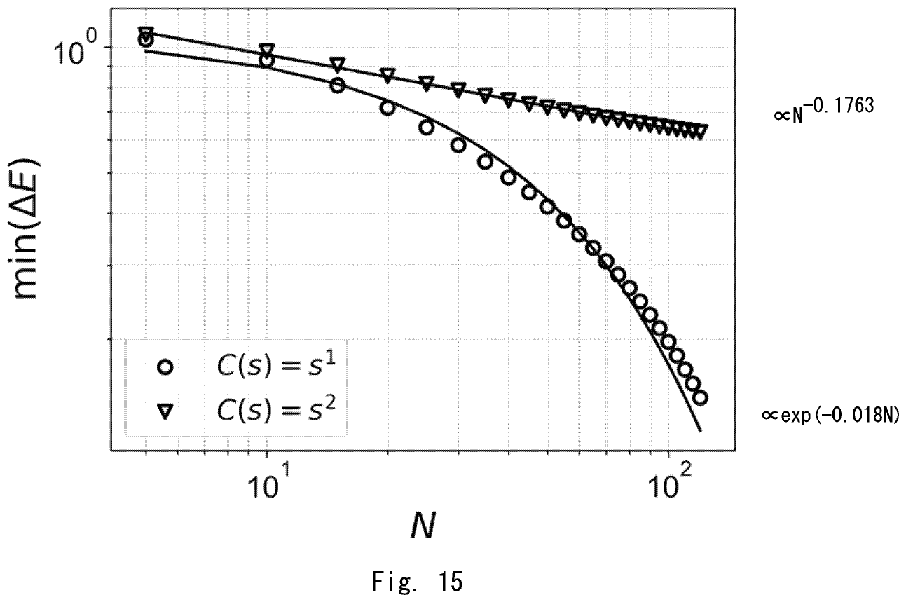

FIG. 15 is a graph showing time required for computation when the number N of quantum bits increases in Expression (10). The horizontal axis indicates the number N of quantum bits. The vertical axis indicates an energy difference min(ΔE) between the energy of an optimal solution and the energy of a solution close to the optimal. It is known that time to required for quantum annealing is proportional to min(ΔE)⁻².

FIG. 15 shows that when C(s)=s², the energy difference changes as a power function of the number N of quantum bits. On the other hand, when C(s)=s, the energy difference decreases as an exponential function. Thus, while the time required for obtaining an optimal solution increases as an exponential function in the related art, the required computation time increases as a power function, which is slower, in this example embodiment.

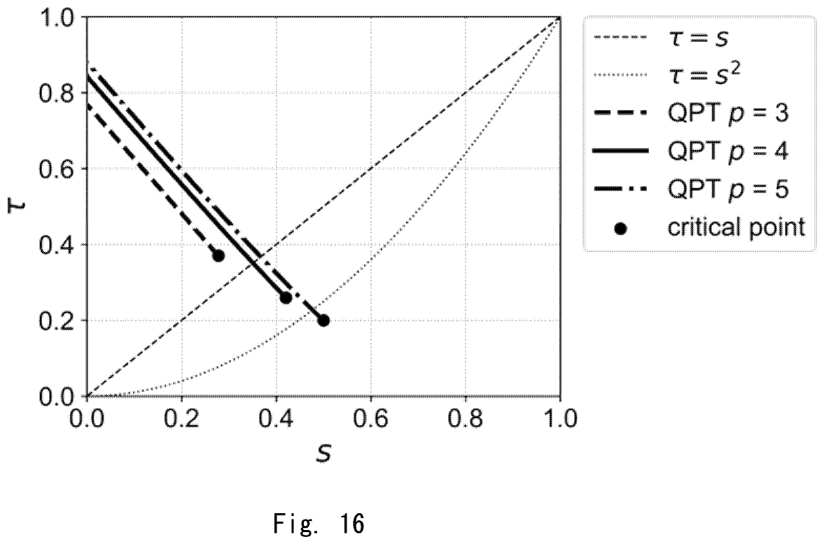

A method of setting C(s) is described theoretically using the model of Expression (10). FIG. 16 shows a result of calculating a phase diagram at absolute zero by using a statistical physics prescription. The horizontal axis is a parameter s for adjusting a weight, and the vertical axis is C(s)=τ. The lines running from the upper left to the lower right are first order phase transition lines (QPT). The first order phase transition lines when p=3, p=4, and p=5 in Expression (10) are shown. The end point (critical point) of the first order phase transition line is a critical point. The position of each critical point can be exactly calculated.

In FIG. 16, each of the graphs of τ=s and τ=s² is the locus when a weighting coefficient τ(C(s)) of the constraint term is a function of s in quantum annealing, which indicates an annealing route. s=τ=0 (lower left of the graph) represents the start point of annealing, and s=τ=1 (upper right of the graph) represents the end point of annealing.

It is known that use of the annealing route intersecting with the first order phase transition line causes the time required for quantum annealing to increase exponentially. The first order phase transition line at p=4 intersects with the annealing route of C(s)=s and does not intersect with the annealing route of C(s)=s². Compared with FIG. 15, in the case of C(s)=s, the energy difference decreases as an exponential function, and the required computation time increases as an exponential function. On the other hand, in the case of C(s)=s², the energy difference decreases as a power function, and the required time does not increase as an exponential function. Therefore, when setting C(s) in this example embodiment, it is preferred to select C(s) that avoids the first order phase transition line (QPT). Note that the difficulty is reduced to a certain degree when it intersects with the first order phase transition line near the critical point. Specifically, although the required time increases exponentially, the degree of increase (the coefficient of the exponent) can be changed.

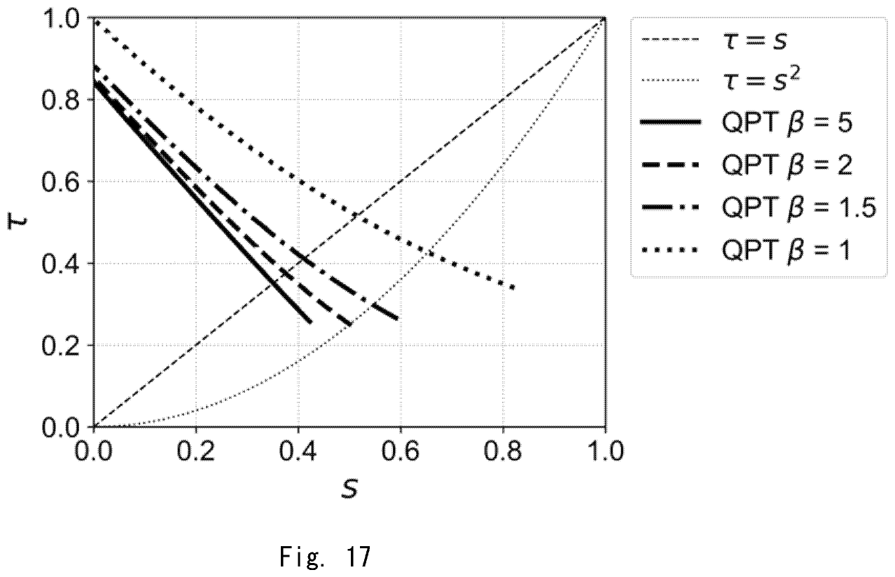

FIG. 17 shows a result of calculating a phase diagram at finite temperature (temperature that is not absolute zero). The horizontal axis is s, and the vertical axis is C(s)=τ. FIG. 17 shows the first order phase transition lines for inverse temperature β=1, 1.5, 2, 5 when p=4 in Expression (10). The inverse temperature β is β∝{1/(temperature)}. Thus, the temperature is higher as β is smaller, and the temperature is lower as β is larger. Each of τ=s and τ=s² is the locus of the annealing route.

As shown in FIG. 17, as the temperature is higher and the inverse temperature is lower, the first order phase transition line is longer. In this case also, the locus of C(s)=s² does not intersect with the first order phase transition line of β=5, and the computation time does not increase exponentially. Further, even if the temperature increases to a certain degree, the first order phase transition line can be avoided by setting C(s)=s³ and s⁴. Thus, this example embodiment is effective not only at absolute zero but also at finite temperature.

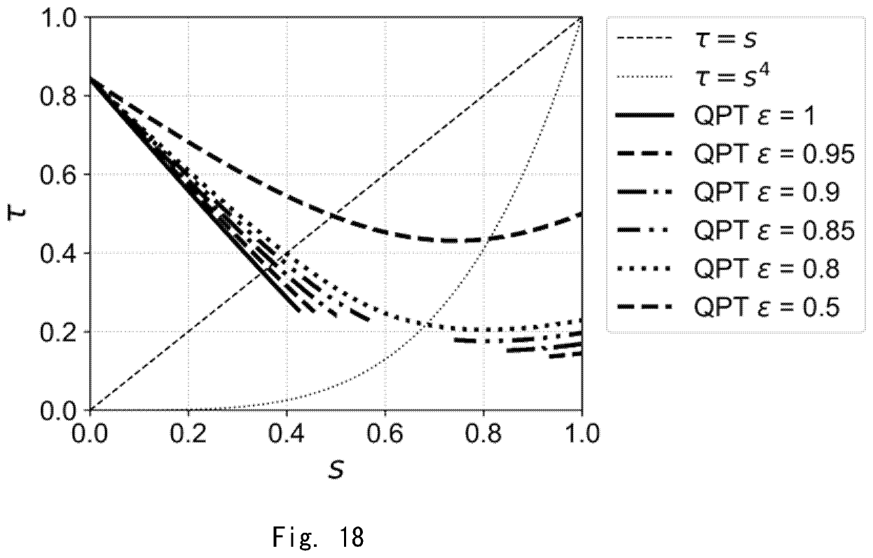

The case where the Hamiltonian is represented by a random magnetic field (binary distribution) is studied below. When p=4 in Expression (11), a phase diagram is calculated for the model where Jᵢ is given by Expression (12). FIG. 18 shows a result of calculating the first order phase transition line (QPT) for six cases of ε=1, 0.95, 0.9, 0.85, 0.8, 0.5. τ=s and τ=s⁴ indicate annealing routes.

$$\begin{matrix}[ Expression 11 ] & \\ H = - ( 1 - s ) {\sum }_{i = 1}^{N} {σ}_{i}^{x} + [ - s {\sum }_{i = 1}^{N} {J}_{i} {σ}_{i}^{z} - C ( s ) {N ( \frac{1}{N} {\sum }_{i = 1}^{N} {σ}_{i}^{z} )}^{p} & ( 11 )\end{matrix}$$

$$\begin{matrix}[ Expression 12 ] & \\ {J}_{i} = \{ \begin{matrix}+ \frac{1}{2} … N ϵ number of bits \\ - \frac{1}{2} … N ( 1 - ϵ ) number of bits\end{matrix} & ( 12 )\end{matrix}$$

In FIG. 18, the phase transition line is divided into two parts at ε=0.85, 0.9, 0.95. In this case also, by setting τ=s⁴, the annealing route can be set to avoid intersection with the phase transition line when ε=0.85, 0.9, 0.95, which allows reducing the computation time.

In FIG. 18, even when τ=s⁴, the first order phase transition line at ε=0.8 and the annealing route intersect with each other, and therefore the computation time increases exponentially with an increase in quantum bits. However, it is known that there are effects caused by a change in the coefficient of the exponential function, which is described below.

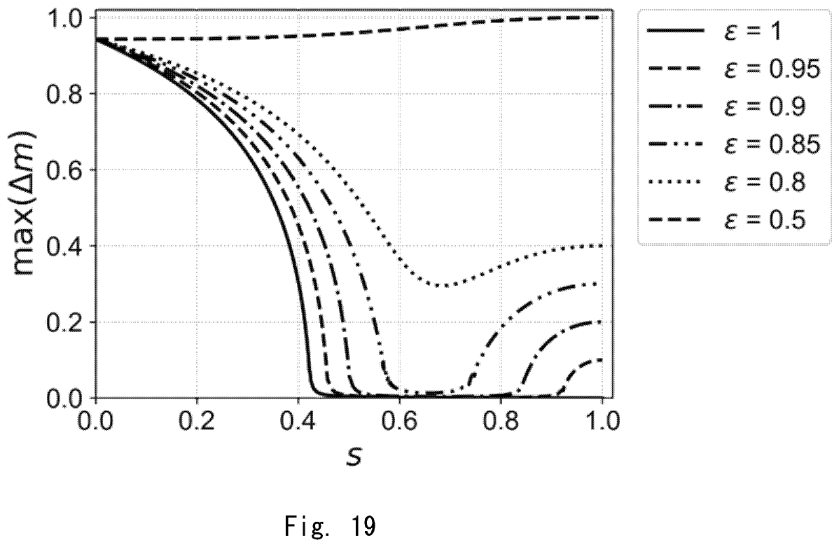

FIG. 19 shows a result of calculating the maximum width of change of magnetization. The vertical axis is the maximum width of change of magnetization, and the horizontal axis is s. The maximum width of change of magnetization represents the strength of phase transition. It is known that, at a point of intersection between the annealing route and the first order phase transition line, the required computation time is shorter as the strength of phase transition is smaller. Further, in FIG. 18, the annealing route at τ=s intersects with the first order phase transition line at ε=0.8 when s=0.4. At this time, the strength of phase transition in FIG. 19 is about 0.7. On the other hand, in FIG. 18, the annealing route at τ=s⁴ intersects with the first order phase transition line at ε=0.8 when s=0.7. At this time, the strength of phase transition in FIG. 19 is about 0.3. Thus, use of this example embodiment allows reducing the strength of phase transition and thereby shortening the required computation time.

### <Hardware Configuration Example>

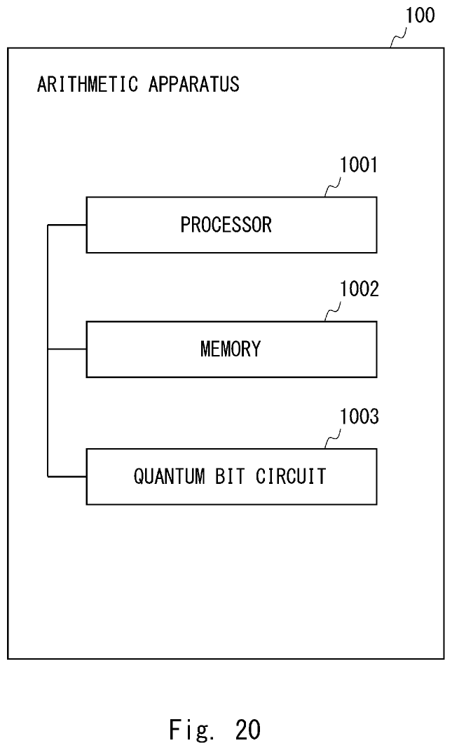

FIG. 20 is a diagram illustrating a hardware configuration for implementing the arithmetic apparatus 100. The arithmetic apparatus 100 includes a processor 1001, a memory 1002, and a quantum bit circuit 1003. The processor 1001 may be various kinds of processors such as a Central Processing Unit (CPU), a Graphics Processing Unit (GPU), or a Field-Programmable Gate Array (FPGA). The processor may be a semiconductor device installed at room temperature or may be a superconductive circuit cooled down to an extremely low temperature from about several mK to about several K. The control unit 101 in the first example embodiment and the second example embodiment may be implemented by the processor 1001 loading the program stored in the memory 1002 and executing the loaded program. The quantum bit circuit 1003 controls the quantum fluctuations of the quantum bit circuit, the strength of the coupling between the quantum bits, and the magnetic field during quantum annealing. The quantum annealing unit in the second example embodiment is implemented by the quantum bit circuit 1003. Regarding the reading unit 103 in the second example embodiment, the processor 1001 may read the state of quantum bits of the quantum bit circuit 1003 and store it into the memory 1002.

The above-described program can be stored and provided to a computer using any type of non-transitory computer readable medium. Non-transitory computer readable media include any type of tangible storage medium. Examples of the non-transitory computer readable medium include a magnetic storage medium, an optical magnetic storage medium, a CD-ROM (Read Only Memory), a CD-R, a CD-R/W, and a semiconductor memory. Examples of the magnetic storage medium include a flexible disk, a magnetic tape, and a hard disk drive. Examples of the optical magnetic storage medium include a magneto-optical disk. Examples of the semiconductor memory include a mask ROM, a PROM (Programmable ROM), an EPROM (Erasable PROM), a flash ROM, and a RAM (Random Access Memory). The program may be provided to a computer using any type of transitory computer readable medium. Examples of the transitory computer readable medium include electric signals, optical signals, and electromagnetic waves. The transitory computer readable medium can provide the program to a computer via a wired communication line such as an electric wire or an optical fiber, or a wireless communication line.

The whole or part of the example embodiments disclosed above can be described as, but not limited to, the following supplementary notes.

### (Supplementary Note 1)

An arithmetic apparatus comprising:

a control unit configured to change a first weighting coefficient assigned to a constraint term included in Hamiltonian so that the first weighting coefficient changes differently from a second weighting coefficient assigned to an objective term included in the Hamiltonian in process of reducing quantum fluctuations to obtain a ground state of the Hamiltonian used for solving a combinatorial optimization problem.

### (Supplementary Note 2)

The arithmetic apparatus according to Supplementary note 1, wherein the control unit changes the first weighting coefficient so that the first weighting coefficient does not exceed the second weighting coefficient in a predetermined period included in the process of reducing quantum fluctuations.

### (Supplementary Note 3)

The arithmetic apparatus according to Supplementary note 2, wherein the control unit changes the first weighting coefficient so that the first weighting coefficient does not exceed the second weighting coefficient at an early stage of the process of reducing quantum fluctuations.

### (Supplementary Note 4)

The arithmetic apparatus according to Supplementary note 2 or 3, wherein the control unit changes the first weighting coefficient so that the first weighting coefficient does not exceed the second weighting coefficient in the process of reducing quantum fluctuations, and changes the first weighting coefficient so that the first weighting coefficient is the same as the second weighting coefficient at an end of the process of reducing quantum fluctuations.

### (Supplementary Note 5)

The arithmetic apparatus according to any one of Supplementary notes 1 to 4, wherein the control unit changes the first weighting coefficient so that the first weighting coefficient is the second weighting coefficient to a power of a value different from 1.

### (Supplementary Note 6)

The arithmetic apparatus according to any one of Supplementary notes 1 to 5, wherein the control unit changes the first weighting coefficient so that a locus of change in the first weighting coefficient does not intersect with a first order phase transition line when the locus of change in the first weighting coefficient is represented as a function with a variable being the second weighting coefficient.

### (Supplementary Note 7)

The arithmetic apparatus according to any one of Supplementary notes 1 to 6, wherein the constraint term involves three or more many-body interactions.

### (Supplementary Note 8)

The arithmetic apparatus according to any one of Supplementary notes 1 to 7, wherein the control unit generates a first control signal for changing the first weighting coefficient, a second control signal for changing the second weighting coefficient, and a third control signal for changing a third weighting coefficient used for reducing the quantum fluctuations.

### (Supplementary Note 9)

The arithmetic apparatus according to Supplementary note 8, further comprising:

a quantum annealing unit configured to apply quantum fluctuations to a plurality of quantum bits and change strength of interactions between the quantum bits on the basis of the first to third control signals.

### (Supplementary Note 10)

The arithmetic apparatus according to Supplementary note 9, further comprising:

a reading unit configured to read states of the quantum bits.

### (Supplementary Note 11)

An arithmetic method comprising:

changing a first weighting coefficient assigned to a constraint term included in Hamiltonian so that the first weighting coefficient changes differently from a second weighting coefficient assigned to an objective term included in the Hamiltonian in process of reducing quantum fluctuations to obtain a ground state of the Hamiltonian used for solving a combinatorial optimization problem.

### (Supplementary Note 12)

The arithmetic method according to Supplementary note 11, wherein the first weighting coefficient is changed so that the first weighting coefficient does not exceed the second weighting coefficient in a predetermined period included in the process of reducing quantum fluctuations.

### (Supplementary Note 13)

A non-transitory computer readable medium storing a program causing a computer to perform:

processing of changing a first weighting coefficient assigned to a constraint term included in Hamiltonian so that the first weighting coefficient changes differently from a second weighting coefficient assigned to an objective term included in the Hamiltonian in process of reducing quantum fluctuations to obtain a ground state of the Hamiltonian used for solving a combinatorial optimization problem.

### Reference Signs List

100 ARITHMETIC APPARATUS

101 CONTROL UNIT

102 QUANTUM ANNEALING UNIT

103 READING UNIT

1001 PROCESSOR

1002 MEMORY

1003 QUANTUM BIT CIRCUIT

a1-a6, c12-c56 QUANTUM BITS

b12-b56 COUPLING

d1-d10 INTERACTION

1. An arithmetic apparatus comprising:
at least one memory storing instructions; and
at least one processor configured to execute the instructions to:
change a first weighting coefficient assigned to a constraint term included in Hamiltonian so that the first weighting coefficient changes differently from a second weighting coefficient assigned to an objective term included in the Hamiltonian in process of reducing quantum fluctuations to obtain a ground state of the Hamiltonian used for solving a combinatorial optimization problem.

2. The arithmetic apparatus according to claim 1, wherein the processor is further configured to execute the instructions to:
change the first weighting coefficient so that the first weighting coefficient does not exceed the second weighting coefficient in a predetermined period included in the process of reducing quantum fluctuations.

3. The arithmetic apparatus according to claim 2, wherein the processor is further configured to execute the instructions to:
change the first weighting coefficient so that the first weighting coefficient does not exceed the second weighting coefficient at an early stage of the process of reducing quantum fluctuations.

4. The arithmetic apparatus according to claim 2, wherein the processor is further configured to execute the instructions to:
change the first weighting coefficient so that the first weighting coefficient does not exceed the second weighting coefficient in the process of reducing quantum fluctuations, and change the first weighting coefficient so that the first weighting coefficient is the same as the second weighting coefficient at an end of the process of reducing quantum fluctuations.

5. The arithmetic apparatus according to claim 1, wherein the processor is further configured to execute the instructions to:
change the first weighting coefficient so that the first weighting coefficient is the second weighting coefficient to a power of a value different from 1.

6. The arithmetic apparatus according to claim 1, wherein the processor is further configured to execute the instructions to:
change the first weighting coefficient so that a locus of change in the first weighting coefficient does not intersect with a first order phase transition line when the locus of change in the first weighting coefficient is represented as a function with a variable being the second weighting coefficient.

7. The arithmetic apparatus according to claim 1, wherein the constraint term involves three or more many-body interactions.

8. The arithmetic apparatus according to claim 1, wherein the processor is further configured to execute the instructions to:
generate a first control signal for changing the first weighting coefficient, a second control signal for changing the second weighting coefficient, and a third control signal for changing a third weighting coefficient used for reducing the quantum fluctuations.

9. The arithmetic apparatus according to claim 8, further comprising:
a quantum annealing circuit configured to apply quantum fluctuations to a plurality of quantum bits and change strength of interactions between the quantum bits on the basis of the first to third control signals.

10. The arithmetic apparatus according to claim 9, wherein the processor is further configured to execute the instructions to:
read states of the quantum bits.

11. An arithmetic method comprising:
changing a first weighting coefficient assigned to a constraint term included in Hamiltonian so that the first weighting coefficient changes differently from a second weighting coefficient assigned to an objective term included in the Hamiltonian in process of reducing quantum fluctuations to obtain a ground state of the Hamiltonian used for solving a combinatorial optimization problem.

12. The arithmetic method according to claim 11, wherein the first weighting coefficient is changed so that the first weighting coefficient does not exceed the second weighting coefficient in a predetermined period included in the process of reducing quantum fluctuations.

13. A non-transitory computer readable medium storing a program causing a computer to perform:
processing of changing a first weighting coefficient assigned to a constraint term included in Hamiltonian so that the first weighting coefficient changes differently from a second weighting coefficient assigned to an objective term included in the Hamiltonian in process of reducing quantum fluctuations to obtain a ground state of the Hamiltonian used for solving a combinatorial optimization problem.
